(19) United States
(12) Patent Application Publication
(10) Pub. No.: US 2016/0233795 A1
(43) Pub. Date: Aug. 11, 2016

(54) DEVICE WITH RIGID SHELL DESIGNED TO UNDERGO IMPACTS AND COMPRISING INTERNAL ENERGY RECOVERY MEANS

(71) Applicant: COMMISSARIAT A L'ENERGIE ATOMIQUE ET AUX ENERGIES ALTERNATIVES, Paris (FR)

(72) Inventors: Guillaume Savelli, Grenoble (FR); Philippe Coronel, Barruax (FR)

(21) Appl. No.: 15/023,255

(22) PCT Filed: Jul. 31, 2014
(86) PCT No.: PCT/FR2014/051995

§ 371 Date: Mar. 18, 2016

(30) Foreign Application Priority Data
Sep. 25, 2013 (FR) 1359233

(51) Int. Cl. H02N 2/18; A63B 43/00; B63H 9/06; A63B 49/00; A63B 60/46; B62M 3/08; A43B 3/00; A63B 67/14

(52) U.S. Cl. CPC H02N 2/18; A43B 3/0015; A63B 43/004; A63B 67/14; A63B 49/00; A63B 60/46; B62M 3/08; B63H 9/0657

(57) ABSTRACT

A device includes a rigid outer shell defining a hollow inner space. The device also includes an inner shell defining a hollow inner space. The inner shell is housed in the inner space of the outer shell and capable of freely displacing therein and including at least one layer of piezoelectric material capable of generating electric energy under the effect of an impact to which it is submitted against the outer shell. An electric circuit is housed in the inner space of the inner shell, electrically connected to the piezoelectric material layer, and includes an element for storing the electric energy generated by the piezoelectric material layer of the inner shell. Further, the device includes elements for holding the electric circuit in the inner shell.

### CROSS-REFERENCE TO RELATED APPLICATIONS

This application is a national stage application under 35 U.S.C. §371 and claims the benefit of priority of international application no. PCT/FR2014/051995, filed Jul. 31, 2014, which claims the benefit of priority under 35 U.S.C. §119 of French patent application no. 1359233, filed Sep. 25, 2013, and the entire contents of each is hereby incorporated herein by reference, in its entirety and for all purposes.

### TECHNOLOGICAL FIELD

The present disclosure relates to the functionalization of rigid objects intended to receive impacts, especially balls or pucks, in particular in sports and/or physical restoration.

### BACKGROUND

In rigid shell ball and puck sports and in physical restoration based on such objects, it is useful to have statistics enabling players to analyze their game and medical staff to assess the quality of the exercises practiced by the patients. Usually, such statistics are manually collected by, for example, counting the number of hits, bounces, or others that a player or a patient exerts on a ball during a determined time period.

Further, certain sports consume a large quantity of balls, the latter having a limited lifetime, and the balls need to be recycled, which generates a non-negligible cost.

It is also advantageous to integrate in balls electronic functions enabling to automatically make statistics and/or to convert into electric energy and store the mechanical energy provided to these objects during the use thereof.

Document US 2011/136603 discloses a sports ball comprising a deformable shell defining a pressurized inner space, such as for example a tennis ball, and comprising an energy recovery circuit based on a piezoelectric material, which converts part of the mechanical energy received by the shell under the effect of its deformation by an impact, into electric energy, and which stores the electric energy thus generated in a battery internal to the ball. The energy thus recovered and stored is used by a circuit internal to the ball, such as for example, an accelerometer, a pressure sensor, or a GPS system.

This document is dedicated to balls having a deformable shell and the piezoelectric material is arranged on or inside of the deformable shell. The flexible shell being deformable, the piezoelectric material thus also undergoes deformations, which enables to generate a large quantity of electric charges. However, assuming that the teachings of this document are applied to an object having a rigid shell, for example, a puck, where the impact does not deform the object, the generation of electric charges is then induced by the acoustic waves which propagate from the rigid shell to the piezoelectric material. Moreover, document US 2011/136603 says nothing of the way to integrate such electric elements and of what happens with the circuits embarked in balls once said balls are worn out.

Further, the question of energy generation and of the integration of an energy recovery function and/or of an electronic function, such as for example a counting function, is posed in the same terms for any rigid object intended to be submitted to impacts or accelerations on use thereof.

### SUMMARY OF THE DISCLOSURE

The present disclosure aims at providing a rigid device which comprises efficient electric energy generation means.

To achieve this, an object of the disclosed embodiments is a device comprising a rigid outer shell delimiting a hollow inner space. The device includes a rigid inner shell defining a hollow inner space, the inner shell being housed in the inner space of the outer shell and capable of freely moving therein. The inner shell includes at least one layer of piezoelectric material capable of generating electric energy under the effect of a impact to which it is submitted against the outer shell. An electric circuit is housed in the inner space of the inner shell, and is electrically connected to the piezoelectric material layer. The inner shell includes an element for storing electric energy generated by the piezoelectric material layer of the inner shell. The device also includes elements for holding the electric circuit in the inner shell.

“Rigid” here means a shell which does not substantially deform under the effect of impacts to which it is submitted during a standard use of the shell. “Deformable” here means an element which deforms under the effect of impacts to which it is submitted during a standard use.

“Free to move” here means that the internal object is not connected, linked or fastened to the inner shell, or that it is connected thereto by means of a holding system applying a low pull-back force opposing as little as possible the motions of the internal object.

In other words, a cavity is provided in the rigid device and the generation of electric energy is performed by an object comprising a piezoelectric shell and free to move in this cavity. Under the effect of an impact or of an acceleration, the internal object thus hits the cavity wall, which generates electric charges by piezoelectric effect. Further, the object may receive shocks several times, which increases the total quantity of generated electric charges.

According to an embodiment, the inner wall of the outer shell is provided with rigid protruding spikes regularly arranged on said wall. Thereby, the spikes directly excite the piezoelectric shell. Particularly, when the piezoelectric shell comprises an outer piezoelectric membrane, the spikes enable to increase the electric charge generation.

According to an embodiment, the inner shell is rigid. More particularly, the rigid inner shell is made of a rigid piezoelectric material, such a material having piezoelectric performances higher than those of a flexible piezoelectric material.

As a variation, a flexible piezoelectric membrane is applied against the external wall of the rigid inner shell. Such a membrane can thus follow the shape of the outer wall of the inner shell, which enables to be free of the geometry of the inner shell. Further, since it is placed on the outer surface of the shell, the piezoelectric membrane directly receives impacts, thereby generating more electric charges. Advantageously, the rigid inner shell has a geometry selected to be sensitive in all directions. Particularly, the rigid inner shell is spherical. As a variation, the inner space of the outer shell and the outer wall of the inner shell have the same geometry as the outer wall of the outer shell. Thereby, the generated electric charges faithfully depict the impacts received by the outer shell. For example, an ice hockey puck comprises an inner space and an inner shell having the same shape as the puck itself.

Advantageously, the rigid inner shell forms a package for the electric circuit and the holding elements are fastening elements securing the electric circuit to the package, which provides an easy-to-form compact internal object.

As a variation, the electric circuit comprises a rigid structure and the holding elements comprise longilineal resilient elements capable of holding the electric circuit in a predetermined position in the inner space of the inner shell, each longilineal holding element being arranged between the rigid structure of the electric circuit and an inner wall of the inner shell. Thereby, the circuit is held at the center of the inner shell and the resilient holding means absorb the impacts received by the inner shell, thereby protecting the electronic circuits. Particularly, the holding elements are formed of springs. Springs have the advantage of requiring a limited volume of matter to efficiently implement a pull-back force, and thus disturb as little as possible the operation, for example, aerodynamic, of the device.

Advantageously, the inner shell comprises a layer of shock-absorbing material between a layer of piezoelectric material and the electric circuit, for example, a layer of foam, gel, polyester, PCM (“Phase change material”), or paper, to protect the electric circuit. For example, the inner shell comprises two concentric rigid walls defining a space filled with a shock-absorbing material.

According to an embodiment, at least two of the holding elements are electrically conductive and form two electric connections between the piezoelectric layer of the inner shell and the electric circuit. It is thus not necessary to provide other types of electric connection, such as, for example, welded wires. Further, such connections resist shocks.

According to an embodiment, the electric circuit is formed of parallelepipedal electric stages arranged in parallel in a rigid frame. This type of configuration provides a compact circuit, which thus only very little disturbs the operation of the device.

According to an embodiment, the device comprises a piezoelectric membrane applied against the inner wall of the outer shell and an electric circuit fastened to the inner wall of the outer shell, electrically connected to the piezoelectric membrane of the outer shell, and comprising an element for storing electric energy generated by the piezoelectric membrane of the outer shell. Thereby, all the elements receiving shocks generate electric charges under the effect of an impact or of an acceleration, thereby increasing the quantity of generated charges.

According to an embodiment, the electric circuit comprises a circuit for generating data from the electric energy generated by the piezoelectric layer of the inner shell, and a circuit of wireless transmission of said data outside of the outer shell, said generation and transmission circuits being powered by the electric energy storage element.

According to an embodiment, the electric energy storage element comprises a microbattery formed on a flexible or rigid substrate and/or a capacitor and/or a supercapacitor. This type of electric energy storage is very light, usually with a low weight and surface area for a large storage capacity.

Advantageously, the inner shell is connected to the outer shell by means of a system for pulling back the inner shell to a predetermined position of the inner space of the outer shell, which enables to generate a minimum electric charge whatever the direction of an impact, of an acceleration, or of a jolt to which the device is submitted.

Particularly, the device is a ball, a puck, a bicycle pedal, a shoe sole, an oar, a sail, a stick, a bat, or a racket.

### BRIEF DESCRIPTION OF THE DRAWINGS

The various embodiments will be better understood on reading of the following description provided as an example only in relation with the accompanying drawings, where:

FIG. 1 is a simplified cross-section view of a ball according to a first embodiment where a flexible piezoelectric material is used;

FIG. 2 is a simplified perspective view of a portion of the flexible piezoelectric membrane and of the holding elements of FIG. 1;

FIG. 3 is a simplified cross-section view of the piezoelectric membrane of FIG. 1;

FIG. 4 is a simplified perspective view of the circuit and of the electric holding elements of FIG. 1;

FIG. 5 is a simplified perspective view of the circuit and of the electric holding elements according to an embodiment;

FIGS. 6 and 7 are simplified views of the holding elements according to two embodiments;

FIGS. 8, 9, and 10 are simplified views of electric connections between the piezoelectric membrane and the electric circuit of FIG. 1 according to a plurality of embodiments;

FIGS. 11 and 12 respectively are perspective and cross-section views of a second embodiment where a rigid piezoelectric material is used;

FIGS. 13 and 14 are respective perspective and cross-section view of a variation of the second embodiment;

FIG. 15 is a perspective view of a variation of the second embodiment;

FIG. 16 is a cross-section view of a third embodiment where the inner wall of the outer shell is piezoelectric; and

FIG. 17 is a cross-section view of a variation comprising springs for pulling back the internal object to a predetermined position.

### DETAILED DESCRIPTION

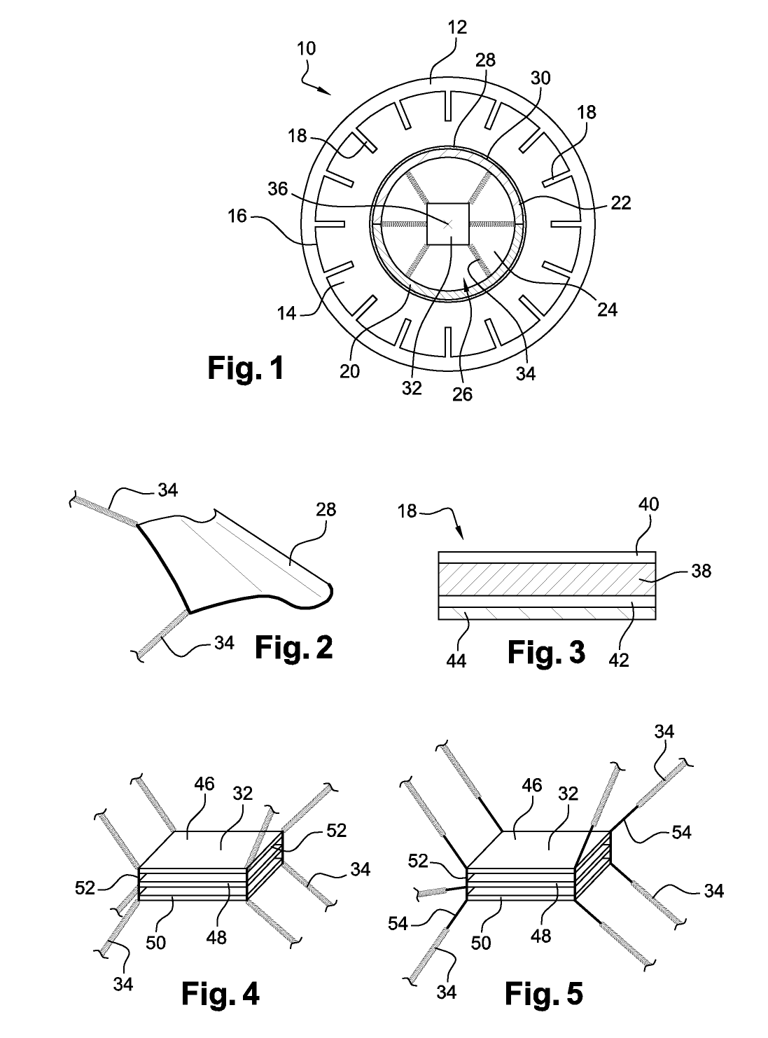

A device with a rigid shell 10 according to a first embodiment, for example, a golf ball, a field hockey ball, a pétanque ball, etc. will now be described in relation with FIGS. 1 to 8.

Device 10 comprises a rigid shell 12 defining an inner space 14. Inner space 14 is for example naturally present in the object or is formed for objects usually provided to be solid. Shell 12 may thus form most of the volume of object 10. Inner wall 16 of shell 12 is further optionally provided with spikes 18, advantageously regularly distributed on said wall 16. The spikes are rigid, for example, made of graphite, or formed of springs having a very high rigidity, the use of springs enabling to increase the force of impacts on internal object 20. Finally, an inner object 20, for example, spherical, is provided in inner space 14 and may freely move therein.

Inner object 20 comprises a shell 22 defining an inner space 24 and formed of a light rigid material, such as for example, graphite, plastic, an elastomer.

Internal object 20 further comprises an energy recovery system 26 which comprises: a flexible piezoelectric membrane 28 following the shape of outer surface 30 of shell 22, advantageously all over said surface, piezoelectric membrane 28 releasing electric charges when it deforms; an electric circuit 32 electrically connected to membrane 28 and comprising an element for converting the electric charges generated by membrane 28 into a constant current and/or voltage and one or a plurality of elements for storing the electric energy generated by the conversion element, as well as, optionally, an electronic circuit implementing one or a plurality of functions described hereafter; an assembly of holding elements 34 positioning electric circuit 32 at center 36 of inner space 24 by implementing forces for pulling back to said position, and capable of deforming in relation with the deformations undergone by shell 22 so as not to oppose them.

Electric circuit 32 and the assembly of holding elements are inserted in inner space 24 of inner shell 22.

Thus, when device 10 is submitted to an impact, an acceleration, or a jolt, for example, internal object 20 hits shell 12, possibly provided with spikes 18. Piezoelectric membrane 28 applied against shell 22 is thus submitted to a deformation and thus generates electric charges which are then stored and/or processed in circuit 32 as described hereabove.

Advantageously, shell 22 is made of or comprises a layer of shock-absorbing material, for example, a layer of foam, gel, polyester, PCM, or paper. The piezoelectric film being placed outside of shell 22, it is fully submitted to the impacts of the internal object against the inner wall of outer shell 12. However, by providing a shock-absorbing shell 22, electric circuit 32 is protected from impacts.

As illustrated in FIGS. 2 and 3, piezoelectric membrane 28 comprises:

a piezoelectric film 38, having a thickness advantageously in the range from 10 micrometers to 200 micrometers, formed in one piece or in a plurality of pieces;

two metal layers 40, 42, having a thickness in the range from a few nanometers to a few tens of micrometers each, deposited on either side of piezoelectric film 38, for example, made of silver, of copper nitride, of aluminum, and forming two electrodes for collecting the electric charges generated by film 38;

optionally, a flexible substrate 44, for example, made of plastic, such as polyethylene terephthalate (“PET”) or polyethylene naphthalate (“PEN”), having the stack of piezoelectric film 28 interposed between metal electrodes 30, 32 formed thereon.

Advantageously, piezoelectric film 38 is made of polyvinylidene fluoride (“PVDF”) which has the advantage of being both light, flexible, and mechanically resistant, metal electrodes 40, 42 being capable of being directly deposited on the film surfaces without using a substrate 44. As a variation, film 38 is made of lead zirconium titanium (“PZT”), of zinc oxide (“ZnO”), or of a composite material of at least two materials from among these and PVDF.

Electric circuit 22 is selected to be as light as possible given the functions that it implements. Particularly, the electric power storage element is advantageously formed of a microbattery formed on a flexible or rigid substrate. For example, the storage element is a rigid substrate microbattery from the “EnerChip” range of Cymbet® Corp., for example, a microbattery bearing reference “CBC050-M8C” having a 8×8 mm² surface area for a 50 μAh capacity, or a Solicore®, Inc. flexible substrate microbattery, for example, a microbattery bearing reference “SF-2529-10EC” having a foldable surface of 25.75×29 mm² for a 10-mAh capacity. As a variation, the electric power storage element comprises one or a plurality of capacitors and/or one or a plurality of supercapacitors and/or one or a plurality of rechargeable button cells.

Circuit 32 is also advantageously designed to have the highest possible three-dimensional symmetry, circuit 32 ideally having a spherical shape and a uniform density. However, given usual electric and electronic circuit manufacturing methods, the circuits generally have a parallelepipedal shape. Advantageously, circuit 32 takes the shape of a stack of parallelepipedal circuits, such as illustrated in FIGS. 4 and 5, to obtain a cuboid shape, advantageously a cube.

Circuit 32 thus comprises, in particular:

a first stage 46 electrically connected to piezoelectric membrane 28, and converting the charges that it generates, essentially in the form of a non-constant current, into a constant current and/or a constant voltage, currently used to charge a microbattery, such as for example a circuit of “LTC3588” type of Linear Technology Corp.,

a second stage 48, electrically connected to first stage 36, comprising a microbattery charging due to the constant current and/or voltage generated by the first stage,

and, optionally, one or a plurality of third stages 50 electrically connected to the battery of second stage 48 for their electric power supply, and implementing one or a plurality of electronic functions as will be described in further detail hereafter, or comprising one or a plurality of additional electric energy storage elements.

The stages are further secured by means of a rigid frame 52 having holding elements 34 fastened thereto.

Holding elements 34 have a longilineal shape, and each of elements 34 is fastened at a first end to electric circuit 32, particularly to frame 52 thereof. Advantageously, the other end of element 34 is laid against the inner wall of inner shell 22, without being secured thereto. For example, elements 34 are assembled in compression in inner shell 22.

Elements 34 are fastened to the frame of circuit 42 and to the inner wall of the inner shell by gluing, by welding, by magnetic contact, by screwing, by a self-locking system, or by means of a quickconnect-type system. As a variation, the fastening is performed by means of a polymer material, such as, for example, a polyurethane, an epoxy glue, an anaerobic glue comprising a mixture of glycol dimethacrylate with a minority quantity of peroxide and of setting accelerator, a cyanoacrylate, or an MS polymer mastic based on modified silane. As a variation, the fastening is performed by means of nanofibers, for example, collagen nanofibers, carbon and copper nanofibers, SiC nanowires comprising carbon microtips.

Circuit 32 and holding elements 34, thus advantageously form, optionally, one and the same object, which facilitates its installation in inner object 20 as well as its removal.

As illustrated in FIG. 4, holding elements 34 are advantageously formed of springs, a spring having a significant pull-back force while being hollow, and thus light. For example, the springs are made of steel, stainless or not, particularly A1S1302 or A1S1316 stainless steel, of a nickel and chromium alloy, for example, inconel® 600, 625, or 718, of copper, or of beryllium.

Further, the springs are selected to be deformable along their main pull-back axis and substantially more rigid perpendicularly to this axis, which eases the placing into contact of their second end with shell 22. In the context of an electric circuit 32 having a parallelepiped shape, there are advantageously eight springs, one spring being provided for each corner of circuit 32. As a variation, as illustrated in FIG. 5, the holding elements also comprise a rigid rod 54, positioned between circuit 32 and the springs, to rigidify system 26 and thus make the latter more mechanically robust. According to an embodiment, holding elements 34 also comprise a piezoelectric material, which also enables to recover energy during the deformation thereof.

Holding elements 34 further have a pull-back force when stretched and/or compressed so that circuit 32 can displace in inner space 24 of object 20 without ever impacting internal wall 30 under the effect of violent shocks affecting object 20 on use of device 10.

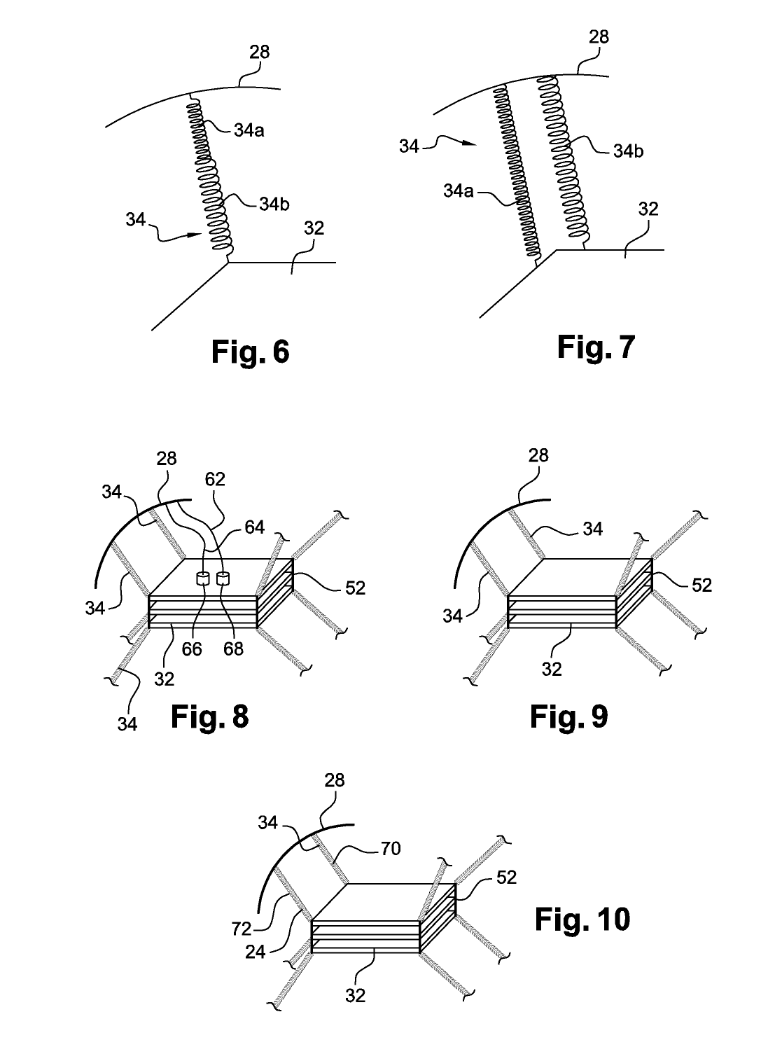

Advantageously, holding elements 34 each comprise a plurality of springs 34a, 34b, for example, two, connected in series, as illustrated in FIG. 6, or in parallel, as illustrated in FIG. 7, which enables to more easily define a different behavior of elements 34 according to the intensity of the impact received by shell 22. Particularly, by providing a plurality of different springs, it is possible to simply design holding elements 34 which have both a low rigidity, that is, which are capable of absorbing the mechanical energy of a shock to protect circuit 32, and a sufficient rigidity, that is, avoiding the collision of circuit 32 on shell 22 during impacts received by shell 22.

FIGS. 8, 9, and 10 illustrate alternative electric connections between piezoelectric membrane 28 and electric circuit 32 to transmit thereto the electric charges generated by the membrane.

According to a first variation illustrated in FIG. 8, the two electrodes 40, 42 of membrane 28 are connected to circuits 32, particularly its constant current/voltage conversion circuit 46, by means of two conductive wires 62, 64 welded to said electrodes and to two pads 66, 68 of circuit 32. One or two holes are formed in shell 22 to have the wires pass therethrough and to connect wires 62, 64 to electrodes 40, 42, or shell 22 comprises across its thickness two conductive pads, having electrodes 40, 42 and conductive wires 62, 64 respectively connected thereto, respectively connected to said pads. In this variation, wires 62, 64 are free to be positioned independently from elements 34 and from frame 52.

According to a second variation illustrated in FIG. 9, two of holding elements 34 are electrically conductive and are connected, through shell 22, for example, by welding, to electrodes 40, 42 and to conductive portions of circuit 32 forming the electric inputs of circuit 32, particularly of conversion circuit 46.

According to a third variation, illustrated in FIG. 10, elements 34 are hollow, for example, formed of springs, and the connection is formed by two conductive wires 70, 72 housed in two of elements 34, and fastened through shell 22, for example, by welding, to electrodes 40, 42 of membrane 28 and circuit 32, for example, to pads thereof or to conductive portions of frame 52 forming electric inputs of circuit 32, particularly conversion circuit 46.

The first variation has the advantage of enabling to select a frame independent from the connection between the membrane and circuit 32. However, the wires are fully submitted to the accelerations of the ball on impacts thereon, which fragilizes them.

The second variation conversely provides connections which are little sensitive to said accelerations, but requires on the other hand a more complex frame for circuit 32.

The third variation show a compromise between the first two variations, where the wires are protected by elements 34 and the connection to circuit 32 may be independent from the frame, for example, by providing a wire portion arranged outside of elements 34 for a connection to pads of circuit 22.

Of course, these variations may be combined. Similarly, more than two connections may be provided. For example, in the case of a piezoelectric membrane 38 comprising a plurality of portions electrically insulated from one another, or “pixelized” membrane, two electric connections may be provided for each of the piezoelectric membrane portions.

Electric circuit 32 may for example comprise one or a plurality of electronic circuits supplied with electric energy by the microbattery of circuit 32 and processing the electric pulses generated by the piezoelectric membrane and generating data. Thus, circuit 32 may for example implement a circuit for counting the number of pulses generated since device 10 has been put into service, a function of determination of the average or individual pulse intensity, and/or of determination of the average or individual pulse duration. The data thus generated are for example stored in an internal memory of circuit 32 and/or transmitted by a wireless transmission circuit, for example, by radiofrequency, from circuit 32 to the outside of device 10 so that they can be collected. Particularly, knowing the number of pulses enables to know, in addition to the number of impacts received by device 10, the wearing state thereof, since this wearing state particularly directly depends on this number for a ball. The number of impacts, their intensity, and their duration further are statistical data useful for a player who can then know the strength of his/her strokes and the type of impact that it applies to the device, etc. . . . Further, by processing the pulses generated by each portion of a pixelized membrane, it is possible to specify the characteristics of the strokes, their shape, and their mark on the device. Further, the analysis of the pulses generated by the piezoelectric membrane also enables to estimate the speed of device 10.

On recycling of device 10, the electric energy storage means of circuit 32 may be discharged to recover the stored energy. Further, internal object 20 may be used again in another device.

Once object 20 is considered out of use, it is sufficient, in order to recover circuit 32, to open shell 22. When holding elements 34 are not fastened to shell 22, it is then sufficient to grab circuit 32 to remove it from shell 22.

The integration of internal object 20 in outer shell 12 then comprises providing the outer shell in two half-shells, each lined, for example, with a membrane covered with spikes 18, to be housed in internal object 20 in one of the two half-shells and then assembling the two half-shells forming outer shell 12, for example, by gluing.

An energy recovery system 26 provided with a flexible piezoelectric membrane 28, and thus capable of being applied to a non-planar surface, and particularly spherical, has been described. The geometry of shell 22 of internal object 20 may thus be selected independently from the piezoelectric material, and particularly selected so that the object is sensitive to impacts in all directions. However, flexible piezoelectric materials usually have piezoelectric performances lower than those of rigid piezoelectric materials.

According to a second embodiment, the piezoelectric material used in internal object 20 is rigid, and forms all or the majority of a hollow shell having electric circuit 32 housed therein.

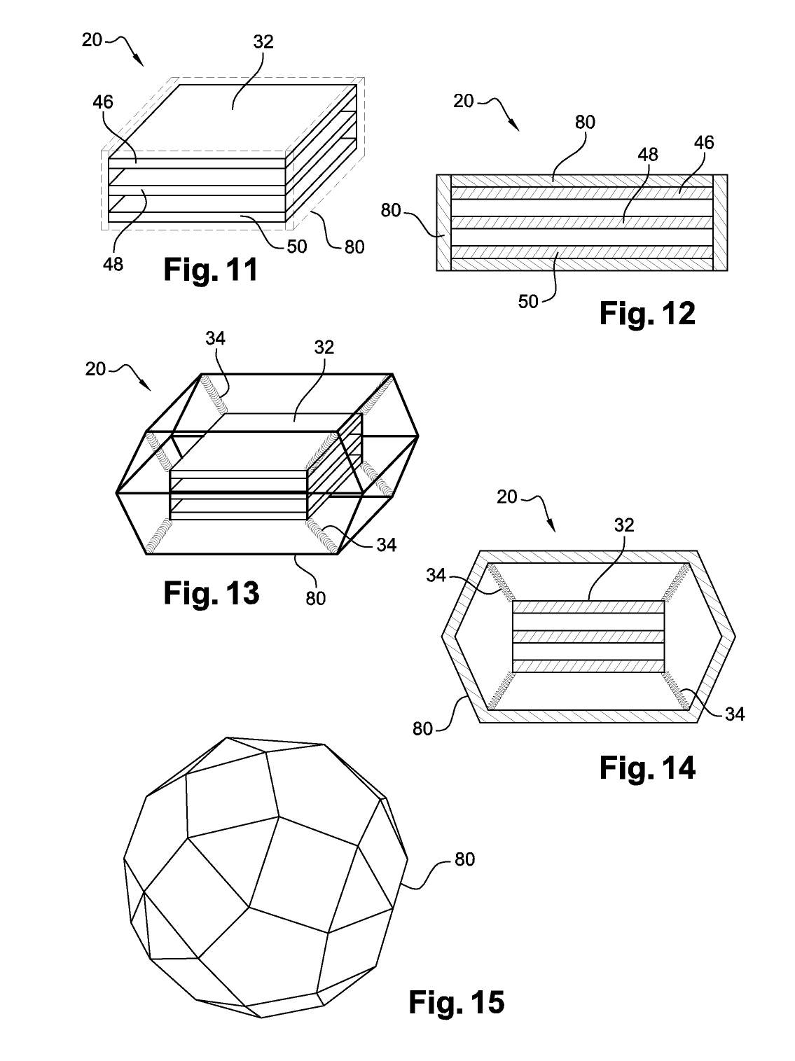

According to a variation illustrated in FIGS. 11 and 12, a piezoelectric shell 80 comprises a layer of rigid piezoelectric material, preferably made of PZT, of a thickness in the range from a few tens of nanometers to a few hundreds of micrometers and interposed between two metal layers forming electrodes. Shell 80 forms a package in the shape of a cuboid for electric circuit 32, the latter being secured to shell 80 for example by gluing, by welding, by magnetic contact, by screwing, by a self-locking system, or by means of a system of quickconnect type. Shell 80 thus forms an additional stage of electric circuit 32, the stage of the circuit comprising the converters being connected to this additional stage by means of appropriate connections, for example, two conductive wires.

This variation has the advantage of having a simple construction. However, the geometry of shell 80 does not enable to be identically sensitive in all directions. As a variation, shell 80 is spherical and for example replaces shell 22 and piezoelectric film 28 of the embodiment illustrated in FIGS. 1 to 8, which enables to obtain a constant sensitivity whatever the direction. However, the manufacturing of a curved layer of rigid piezoelectric material is difficult. Indeed, the manufacturing of a rigid piezoelectric layer is usually performed by means of a physical or chemical vapor deposition, or sol-gel deposition, or by means of a thermosetting material, which techniques do not enable to form non-planar objects. Advantageously, a shell comprising a layer of rigid piezoelectric material is obtained by first forming planar rectangular plates, and then by assembling them, for example, by gluing or by welding, to obtain a polyhedron.

In the variation illustrated in FIGS. 13 and 14, shell 80 is a polyhedron with eight surfaces having an electric circuit 32 housed and held therein, for example, the electric circuit held by holding elements 34 such as described in relation with the first embodiment of FIGS. 1 to 8. As a variation, electric circuit 32 may be directly fastened to shell 80 or rigid holding elements may be used.

Advantageously, the polyhedron is selected to have a large number of surfaces to approximate a sphere, such as for example illustrated in FIG. 15, which enables to obtain a sensitivity substantially independent from the direction.

Embodiments where the piezoelectric material is incorporated in the shell of an object hitting the inner wall of the outer shell of the device have been described. Advantageously, the inner wall of the outer shell of the device is also used to convert the mechanical energy into electric charges, this wall also receiving shocks from the internal object, and is also submitted to acoustic waves originating from the outer wall of the outer shell when the latter is submitted to impacts, strokes, bounces, jolts, or others.

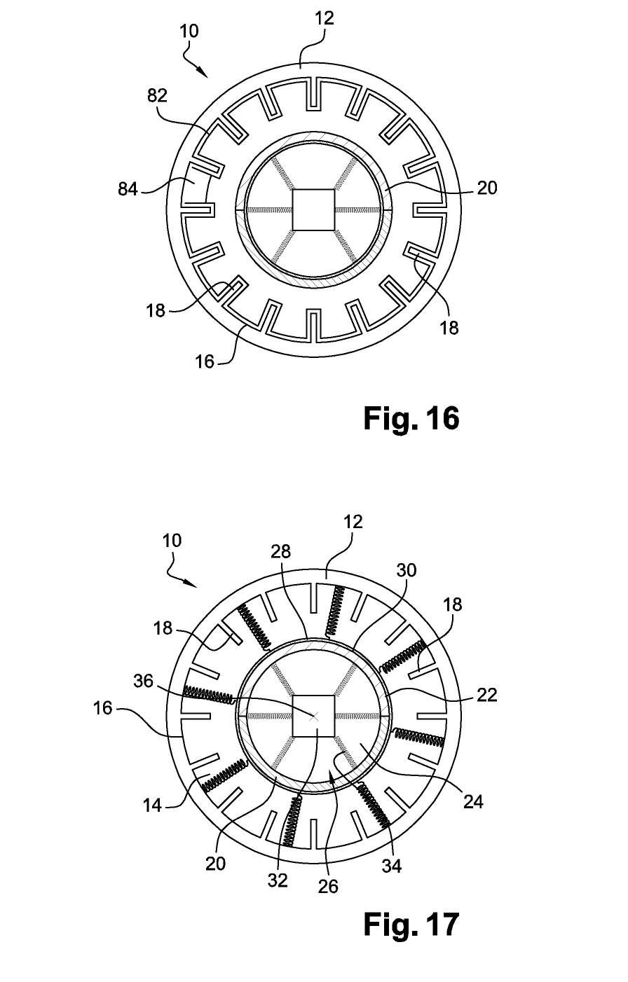

In an embodiment illustrated in FIG. 16, a device comprises an outer shell 12, for example, that described in relation with FIG. 11, housing an internal object 20, for example, any of the previously-described internal elements. Inner wall 16 of outer shell 12 is further covered with a flexible piezoelectric membrane 82, for example, such as described in relation with the first embodiment of FIG. 1, advantageously also on spikes 18, and a second electric circuit 84 is fastened to inner wall 16 of shell 12, connected to piezoelectric membrane 82 and comprising flexible or rigid means for converting and storing the electric charges generated by the latter, for example, the conversion and storage means described in relation with FIG. 1. As a variation, shell 12 integrates a rigid piezoelectric element.

Embodiments where internal object 20 is totally free to move in space 14 of outer shell 12 have been described, internal object 20 comprising no connection with outer shell 12.

Advantageously, a system for pulling back internal object 20 to a predetermined position of inner space 14, for example, the center thereof when the space is spherical, is additionally provided. For example, referring to FIG. 17 which illustrates a device comprising the elements described in relation with FIGS. 1 to 8, springs 90 are also provided between outer shell 12 and inner shell 22 to apply a pull-back force which maintains internal object 20 at the center of space 14 when the device is at rest. The stiffness of springs 90 is selected to provide the smallest possible opposition to the motions of object 20 while applying a force sufficient to hold internal object 20 at the center of space 14 when the device is at rest. Thereby, object 20 is placed so that it has a minimum travel in the inner space. Thus, whatever the direction of the impact, of the acceleration, or of the jolts to which the device is submitted, there exists a minimum generated electric charge.

The described embodiments also apply to balls or pucks which are rigid, that is, which undergo substantially no deformation during their use, such as, for example, golf balls, polo balls, field hockey balls, hockey pucks, baseballs, pétanque balls, or the like.

The described embodiments also apply to other types of sport than ball/puck sports. For example, the described embodiments further apply to bicycling, particularly by providing bicycle pedals comprising a cavity having an internal object free to move inside of it housed therein.

Similarly, the described embodiments apply to shoes, for example, sports shoes for example comprising soles provided with a cavity and with an internal object.

The described embodiments apply to nautical sports. For example, a mast, a sail, a rowing oar and a kayak paddle are provided with a cavity and with an internal object. Thus, each time the previously-described objects are submitted to an impact or an acceleration, electric charges are generated, stored, and processed, which enables to provide statistics, for example.

Of course, the embodiments described apply to other types of activities than sports, particularly physical restoration activities which use balls, pucks, or the like, the statistics generated by such objects enabling medical staff to study, for example, the quality of the exercises performed by the patients.

Further, the described embodiments apply to portable electronic devices, for example, watches, MP3 players, LED lamps, or the like, to mechanical parts in transportation (car, plane, bicycle, road surfacing . . . ), of kitchen utensils, factory equipment (food, organic), which may be recharged by jolts by providing a cavity and an internal object.

1. A device comprising a rigid outer shell defining a hollow inner space, wherein said device comprises:
an inner shell defining a hollow inner space, said inner shell being housed in the inner space of the outer shell and capable of freely moving therein, and comprising at least one layer of piezoelectric material capable of generating electric energy under the effect of an impact to which said layer is submitted against the outer shell;
an electric circuit housed in the inner space of the inner shell, electrically connected to the piezoelectric material layer, and comprising an element for storing the electric energy generated by the piezoelectric material layer of the inner shell; and
elements for holding the electric circuit in the inner shell.

2. The device of claim 1, wherein an inner wall of the outer shell is provided with rigid spikes regularly arranged on said wall.

3. The device of claim 1, wherein the inner shell is rigid.

4. The device of claim 3, wherein the rigid inner shell is made of a rigid piezoelectric material.

5. The device of claim 3, wherein a flexible piezoelectric membrane is applied against an outer wall of the rigid inner shell.

6. The device of claim 3, wherein the rigid inner shell forms a package for the electric circuit, and wherein the holding elements are fastening elements securing the electric circuit to the package.

7. The device of claim 3, wherein the electric circuit comprises a rigid structure, and wherein the holding elements comprise longilineal resilient elements capable of holding the electric circuit in a predetermined position in the inner space of the inner shell, each longilineal holding element being arranged between the rigid structure of the electric circuit and an inner wall of the inner shell.

8. The device of claim 7, wherein the holding elements are formed of springs.

9. The device of claim 1, wherein at least two of the holding elements are electrically conductive and form two electric connections between the piezoelectric layer of the inner shell and the electric circuit.

10. The device of claim 1, wherein the electric circuit is formed of parallelepipedal electric stages arranged in parallel in a rigid frame.

11. The device of claim 1, wherein it comprises a piezoelectric membrane applied against the inner wall of the outer shell and an electric circuit fastened to the inner wall of the outer shell, electrically connected to the piezoelectric membrane of the outer shell, and comprising an element for storing electric energy generated by the piezoelectric membrane of the outer shell.

12. The device of claim 1, wherein the electric circuit comprises a circuit for generating data from the electric energy generated by the piezoelectric layer of the inner shell, and a circuit of wireless transmission of said data outside of the outer shell, said generation and transmission circuits being powered by the electric energy storage element.

13. The device of claim 1, wherein the electric power storage element comprises a microbattery formed on a flexible or rigid substrate and/or a capacitor and/or a supercapacitor or button cells.

14. The device of claim 1, wherein the inner shell is connected to the outer shell by means of a system for pulling back the inner shell to a predetermined position of the inner space of the outer shell.

15. The device of claim 1, wherein the device is a ball, a puck, bicycle pedal, a shoe sole, an oar, a sail, a stick, a bat, or a racket.
